(19) United States
(12) Patent Application Publication
(10) Pub. No.: US 2018/0142098 A1
(43) Pub. Date: May 24, 2018

(54) RESIN COMPOSITION

(71) Applicant: ASAHI KASEI KABUSHIKI KAISHA, TOKYO (JP)

(72) Inventor: Minoru SAKATA, Tokyo (JP)

(73) Assignee: ASAHI KASEI KABUSHIKI KAISHA, TOKYO (JP)

(21) Appl. No.: 15/819,112

(22) Filed: Nov. 21, 2017

(30) Foreign Application Priority Data
Nov. 22, 2016 (JP) 2016-227130

(51) Int. Cl. C08L 71/12; C08L 53/02; C08L 25/06

(52) U.S. Cl. CPC C08L 71/123; C08L 53/025; C08L 2205/035; C08L 2205/03; C08L 2201/02; C08L 25/06

(57) ABSTRACT

Provided is a resin composition having an excellent balance of high impact resistance and fluidity, and excellent ductile fracture properties. The resin composition contains: a polyphenylene ether resin (a); and a hydrogenated block copolymer (b) including a hydrogenated block copolymer component (b-1) that includes two polymer blocks A of mainly a vinyl aromatic compound and two polymer blocks B of mainly a conjugated diene compound, and a hydrogenated block copolymer component (b-2) that includes two polymer blocks A of mainly a vinyl aromatic compound and one polymer block B of mainly a conjugated diene compound, with a mass ratio of the hydrogenated block copolymer component (b-1) relative to the hydrogenated block copolymer component (b-2) (hydrogenated block copolymer component (b-1)/hydrogenated block copolymer component (b-2)) of 5/95 to 95/5. Polypropylene content in the resin composition is less than 5 mass % when all resin components are taken to be 100 mass %, in total.

### TECHNICAL FIELD

This disclosure relates to a resin composition. More specifically, this disclose relates to a resin composition that has excellent fluidity, impact resistance, and the like, and that is suitable for use in home appliance parts, OA device parts, audio visual device parts, automobile parts, and so forth.

### BACKGROUND

Polyphenylene ether resins are widely used in electronic/electrical appliance parts, OA device parts, audio visual device parts, automobile parts, and so forth as shaping materials having excellent heat resistance, dimensional stability, and flame retardance.

In recent years, there has been strong demand for improvement of fluidity in hot-melt processing to enable miniaturization and refinement of resin parts. However, it has become apparent that although typical methods for improving fluidity such as reducing the molecular weight of a resin or adding a plasticizer enable improvement of fluidity, these methods are problematic because they reduce impact resistance. Fluidity can alternatively be improved by implementing melt processing at a higher processing temperature, but this method also reduces impact resistance due to resin thermal degradation associated therewith.

Consequently, numerous ideas have been proposed for improvement from a material perspective through use of elastomers that tend not to thermally degrade.

Examples of such techniques that have been proposed include a resin composition in which a triblock copolymer having an A-B-A type hydrogenated structure, a diblock copolymer having an A-B type hydrogenated structure, a polyolefin, and a phosphate compound are compounded with a polyphenylene ether resin (for example, refer to PTL 1), a resin composition in which two types of triblock copolymers having A-B-A type hydrogenated structures are compounded with a polyphenylene ether (for example, refer to PTL 2), and a resin composition in which a tetrablock copolymer having an A-B-A-B type hydrogenated structure is compounded with a polyphenylene ether (for example, refer to PTL 3).

The documents mentioned above disclose resin compositions that have strong resistance to thermal degradation and excellent impact resistance through compounding of elastomer block copolymers having hydrogenated structures with resins. However, although resin compositions obtained by these techniques have improved impact resistance, these resins do not satisfy current demands in terms of fluidity, heat resistance, and ductile fracture properties, and it would be beneficial to provide a resin composition in which these properties are enhanced.

### CITATION LIST

### Patent Literature

PTL 1: JP H7-150030 A
PTL 2: WO 2015/108646 A1
PTL 3: JP H3-131653 A

### SUMMARY

### Technical Problem

The inventor conducted studies from a viewpoint of improving safety and the like of automobile parts and, as a result, discovered that parts in which the resin compositions described in PTL 1 to 3 are used also suffer from an issue in terms of safety because, during fracture, they exhibit a property (ductile fracture property) of fracture surface scattering, which may result in the generation of sharp fragments. The inventors conducted further studies in relation to resin compositions having an excellent balance of impact resistance and fluidity, and excellent ductile fracture properties.

This disclosure relates to a problem of provision of a resin composition having an excellent balance of high impact resistance and fluidity, and excellent ductile fracture properties.

### Solution to Problem

As a result of diligent investigation to solve the problems set forth above, the inventors discovered that a resin composition that contains a polyphenylene ether resin and in which two types of hydrogenated block copolymer components having specific structures are added in a specific ratio has an excellent balance of high impact resistance and fluidity, and excellent ductile fracture properties. The present disclosure was completed based on this discovery.

Specifically, this disclosure provides the following.

[1] A resin composition comprising:

a polyphenylene ether resin (a); and

a hydrogenated block copolymer (b) including a hydrogenated block copolymer component (b-1) that includes two polymer blocks A of mainly a vinyl aromatic compound and two polymer blocks B of mainly a conjugated diene compound, and a hydrogenated block copolymer component (b-2) that includes two polymer blocks A of mainly a vinyl aromatic compound and one polymer block B of mainly a conjugated diene compound, with a mass ratio of the hydrogenated block copolymer component (b-1) relative to the hydrogenated block copolymer component (b-2) (hydrogenated block copolymer component (b-1)/hydrogenated block copolymer component (b-2)) of 5/95 to 95/5, wherein

polypropylene content is less than 5 mass % when all resin components are taken to be 100 mass %, in total.

[2] The resin composition according to the foregoing [1], wherein

the polyphenylene ether resin (a) includes a polyphenylene ether and a polystyrene resin, and

a mass ratio of the polyphenylene ether relative to the polystyrene resin (polyphenylene ether/polystyrene resin) is 97/3 to 5/95.

[3] The resin composition according to the foregoing [2], wherein

the polystyrene resin is either or both of atactic polystyrene and high impact polystyrene.

[4] The resin composition according to any one of the foregoing [1] to [3], wherein

at least one of the polymer blocks A has a number average molecular weight of 10,000 or more.

[5] The resin composition according to any one of the foregoing [1] to [4], wherein

either or both of the hydrogenated block copolymer component (b-1) and the hydrogenated block copolymer component (b-2) have a number average molecular weight of 40,000 to 250,000.

[6] The resin composition according to any one of the foregoing [1] to [5], wherein

a mass ratio of the polyphenylene ether resin (a) relative to the hydrogenated block copolymer (b) (polyphenylene ether resin (a)/hydrogenated block copolymer (b)) is 98/2 to 50/50.

[7] The resin composition according to any one of the foregoing [1] to [6], further comprising

6 parts by mass to 20 parts by mass of a condensed phosphate ester flame retardant (c) relative to 100 parts by mass, in total, of the polyphenylene ether resin (a) and the hydrogenated block copolymer (b).

### Advantageous Effect

According to this disclosure, it is possible to provide a resin composition having an excellent balance of high impact resistance and fluidity, and excellent ductile fracture properties.

### DETAILED DESCRIPTION

The following provides a detailed description of an embodiment of this disclosure (hereinafter, referred to simply as the “present embodiment”). This disclosure is not limited to the following embodiment and may be implemented with various alterations made within the essential scope thereof.

[Resin Composition]

A resin composition of the present embodiment contains: a polyphenylene ether resin (a); and a hydrogenated block copolymer (b) including a hydrogenated block copolymer component (b-1) that includes two polymer blocks A of mainly a vinyl aromatic compound and two polymer blocks B of mainly a conjugated diene compound, and a hydrogenated block copolymer component (b-2) that includes two polymer blocks A of mainly a vinyl aromatic compound and one polymer block B of mainly a conjugated diene compound, with a mass ratio of the hydrogenated block copolymer component (b-1) relative to the hydrogenated block copolymer component (b-2) (hydrogenated block copolymer component (b-1)/hydrogenated block copolymer component (b-2)) of 5/95 to 95/5. Polypropylene content in the resin composition is less than 5 mass % when all resin components are taken to be 100 mass %, in total.

The resin composition of the present embodiment contains the polyphenylene ether resin (a) and the hydrogenated block copolymer (b), and may optionally contain a condensed phosphate ester flame retardant (c) and other components.

In the resin composition of the present embodiment, the content of component (a) is preferably 98 mass % to 50 mass % and the content of component (b) is preferably 2 mass % to 50 mass % relative to 100 mass %, in total, of components (a) and (b). Moreover, the content of component (c) is preferably 6 parts by mass to 20 parts by mass relative to 100 parts by mass, in total, of components (a) and (b). Through the configuration set forth above, the resin composition of the present embodiment can display an even better balance of physical properties in terms of processability, impact resistance, and flame retardance.

The following describes the components constituting the resin composition of the present embodiment.

(Polyphenylene Ether Resin (a))

The resin composition of the present embodiment contains a polyphenylene ether resin (hereinafter, also referred to simply as a “PPE resin”) as component (a). The resin composition of the present embodiment has excellent flame retardance and heat resistance through inclusion of the polyphenylene ether resin.

The PPE resin preferably includes a polyphenylene ether (also referred to as “PPE” in the present specification) and a polystyrene resin, and may be a mixed resin formed from PPE and a polystyrene resin or a resin formed from only PPE.

The resin composition of the present embodiment has even better flame retardance and heat resistance through inclusion of PPE in the PPE resin.

The PPE may, for example, be a homopolymer composed of a repeating unit structure represented by the following formula (1) or a copolymer including a repeating unit structure represented by the following formula (1).

One type of PPE may be used individually, or two or more types of PPE may be used in combination.

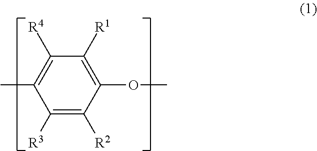

In formula (1), R², R³, and R⁴ are each, independently of one another, a monovalent group selected from the group consisting of a hydrogen atom, a halogen atom, a primary alkyl group having a carbon number of 1 to 7, a secondary alkyl group having a carbon number of 1 to 7, a phenyl group, a haloalkyl group, an aminoalkyl group, a hydrocarbonoxy group, and a halohydrocarbonoxy group in which a halogen atom and an oxygen atom are separated by at least two carbon atoms.

The reduced viscosity of the PPE as measured by an Ubbelohde-type viscometer at 30° C. using a chloroform solution of 0.5 g/dL in concentration is preferably 0.15 dL/g to 2.0 dL/g, more preferably 0.20 dL/g to 1.0 dL/g, and even more preferably 0.30 dL/g to 0.70 dL/g from a viewpoint of fluidity in processing, toughness, and chemical resistance.

Examples of the PPE include, but are not specifically limited to, homopolymers such as poly(2,6-dimethyl-1,4-phenylene ether), poly(2-methyl-6-ethyl-1,4-phenylene ether), poly(2-methyl-6-phenyl-1,4-phenylene ether), and poly(2,6-dichloro-1,4-phenylene ether); and copolymers such as copolymers of 2,6-dimethylphenol and other phenols (for example, 2,3,6-trimethylphenol and 2-methyl-6-butylphenol). Of these examples, poly(2,6-dimethyl-1,4-phenylene ether) and a copolymer of 2,6-dimethylphenol and 2,3,6-trimethylphenol are preferable, and poly(2,6-dimethyl-1,4-phenylene ether) is more preferable from a viewpoint of balance of toughness and rigidity when used in the resin composition and ease of raw material acquisition.

The PPE can be produced by a commonly known method. Examples of methods by which the PPE can be produced include, but are not specifically limited to, a method of oxidatively polymerizing 2,6-xylenol using a complex of a cuprous salt and an amine as a catalyst as described by Hay in U.S. Pat. No. 3,306,874 A, and methods described in U.S. Pat. No. 3,306,875 A, U.S. Pat. No. 3,257,357 A, U.S. Pat. No. 3,257,358 A, JP S52-17880 B, JP S50-51197 A, and JP S63-152628 A.

The PPE may be modified PPE that is obtained by reacting a styrene monomer or derivative thereof and/or an α,β-unsaturated carboxylic acid or derivative thereof with a homopolymer and/or copolymer such as described above. The grafted amount or added amount of the styrene monomer or derivative thereof and/or the α,β-unsaturated carboxylic acid or derivative thereof is preferably 0.01 mass % to 10 mass % relative to 100 mass % of component (a).

The method by which the modified PPE is produced may, for example, be a method in which a reaction is carried out at a temperature of 80° C. to 350° C. in a molten state, solution state, or slurry state, and in the presence or absence of a radical precursor.

The PPE that is used may be a mixture of a homopolymer and/or copolymer such as described above and modified PPE such as described above in any ratio.

The polystyrene resin included in component (a) may, for example, be atactic polystyrene, rubber-reinforced polystyrene (high impact polystyrene; HIPS), a styrene-acrylonitrile copolymer (AS) having a styrene content of 50 wt % or more, or a rubber reinforced AS resin of this styrene-acrylonitrile copolymer, and is preferably atactic polystyrene and/or high impact polystyrene.

One type of polystyrene resin may be used individually, or two or more types of polystyrene resins may be used in combination.

The component (a) may be a polyphenylene ether resin that is formed from PPE and a polystyrene resin, and in which the mass ratio of the PPE relative to the polystyrene resin (PPE/polystyrene resin) is 97/3 to 5/95. The mass ratio of the PPE relative to the polystyrene resin (PPE/polystyrene resin) is more preferably 90/10 to 10/90 from a viewpoint of obtaining even better fluidity.

The content of component (a) in the resin composition of the present embodiment when the total amount of components (a) and (b) is taken to be 100 mass % is preferably 98 mass % to 50 mass % from a viewpoint of processability, heat resistance, impact resistance, and flame retardance. However, the content of component (a) may be 98 mass % to 40 mass %, or 98 mass % to 30 mass %. When the content of component (a) is within a range of 98 mass % to 50 mass %, an adequate balance of processability, heat resistance, impact resistance, and flame retardance can be obtained.

The content of component (a) in the resin composition of the present embodiment relative to the total amount of the resin composition (100 mass %) is preferably 2 mass % to 98 mass % from a viewpoint of flame retardance. Moreover, the content of PPE in the resin composition of the present embodiment relative to the total amount of the resin composition (100 mass %) is preferably 0.25 mass % to 92.2 mass % from a viewpoint of flame retardance.

(Hydrogenated Block Copolymer (b))

The resin composition of the present embodiment contains a hydrogenated block copolymer including at least two types of hydrogenated block copolymer components as component (b). The resin composition of the present embodiment has excellent impact resistance and fluidity through inclusion of the hydrogenated block copolymer.

The hydrogenated block copolymer (b) imparts impact resistance on the resin composition of the present embodiment and is a hydrogenated block copolymer including a hydrogenated block copolymer component (b-1) that is obtained by hydrogenating a block copolymer including two polymer blocks A of mainly a vinyl aromatic compound and two polymer blocks B of mainly a conjugated diene compound, and a hydrogenated block copolymer component (b-2) that is obtained by hydrogenating a block copolymer including two polymer blocks A of mainly a vinyl aromatic compound and one polymer block B of mainly a conjugated diene compound.

The hydrogenated block copolymer (b) may include hydrogenated block copolymer components other than the hydrogenated block copolymer component (b-1) and the hydrogenated block copolymer component (b-2) to the extent that the effects disclosed herein are not lost.

The term “polymer block A of mainly a vinyl aromatic compound” refers to a homopolymer block of a vinyl aromatic compound or a copolymer block of a vinyl aromatic compound and a conjugated diene compound for which the vinyl aromatic compound content in the polymer block A is more than 50 mass %, and preferably 70 mass % or more. The polymer block A may be a polymer block that does not substantially include a conjugated diene compound or a polymer block that does not include a conjugated diene compound. Note that the phrase “does not substantially include” is inclusive of cases in which a conjugated diene compound is included to an extent that does not lead to loss of the effects disclosed herein. For example, the conjugated diene compound content may be 3 mass % or less relative to the total amount of the block.

The term “polymer block B of mainly a conjugated diene compound” refers to a homopolymer block of a conjugated diene compound or a copolymer block of a conjugated diene compound and a vinyl aromatic compound for which the conjugated diene compound content in the polymer block B is more than 50 mass %, and preferably 70 mass % or more. The polymer block B may be a polymer block that does not substantially include a vinyl aromatic compound or a polymer block that does not include a vinyl aromatic compound. Note that the phrase “does not substantially include” is inclusive of cases in which a vinyl aromatic compound is included to an extent that does not lead to loss of the effects disclosed herein. For example, the vinyl aromatic compound content may be 3 mass % or less relative to the total amount of the block.

The hydrogenated block copolymer (b) is preferably a combination of two types of hydrogenated block copolymer components and may be a combination of conventionally known hydrogenated block copolymer components that are commercially available. Moreover, any hydrogenated block copolymer components that correspond to the components (b-1) and (b-2) set forth above can be used.

The vinyl aromatic compound forming the hydrogenated block copolymer (b) is, for example, one compound or two or more compounds selected from styrene, α-methylstyrene, vinyltoluene, p-tert-butylstyrene, and diphenylethylene, and is particularly preferably styrene.

The conjugated diene compound forming the hydrogenated block copolymer (b) is, for example, one compound or two or more compounds selected from butadiene, isoprene, 1,3-pentadiene, and 2,3-dimethyl-1,3-butadiene, and is particularly preferably butadiene, isoprene, or a combination thereof.

The form of bonding of butadiene prior to hydrogenation can normally be determined using an infrared spectrophotometer, an NMR spectrometer, or the like.

The hydrogenated block copolymer component (b-1) is preferably a hydrogenated block copolymer component formed from two blocks A and two blocks B, and is more preferably a hydrogenated product of a vinyl aromatic compound-conjugated diene compound block copolymer having a structure in which A-B-A-B type block units are bonded (note that the molecular weights of the two blocks A may be the same or different and the molecular weights of the two blocks B may be the same or different).

The hydrogenated block copolymer component (b-2) is preferably a hydrogenated block copolymer component formed from two blocks A and one block B, and is more preferably a hydrogenated product of a vinyl aromatic compound-conjugated diene compound block copolymer having a structure in which A-B-A type block units are bonded (note that the molecular weights of the two blocks A may be the same or different).

The structure of the polymer blocks A of mainly a vinyl aromatic compound and the polymer blocks B of mainly a conjugated diene compound may, for example, be a structure in which the distribution of the vinyl aromatic compound or conjugated diene compound in the molecular chain of each polymer block is a random distribution, a tapered distribution (distribution in which the monomer component increases or decreases along the molecular chain), or the like. In a case in which two or more polymer blocks A or two or more polymer blocks B are included in the hydrogenated block copolymer component (b-1) or the hydrogenated block copolymer component (b-2), these polymer blocks may each have the same structure or may have different structures.

One or more polymer blocks B included in the hydrogenated block copolymer component (b-1) or the hydrogenated block copolymer component (b-2) may be a polymer block in which the 1,2-vinyl bond content of the conjugated diene compound prior to hydrogenation is 70% to 90%. Moreover, one of more polymer blocks B included in the hydrogenated block copolymer component (b-1) or the hydrogenated block copolymer component (b-2) may be a polymer block that has both a polymer block (polymer block B1) in which the 1,2-vinyl bond content of the conjugated diene compound prior to hydrogenation is 70% to 90% and a polymer block (polymer block B2) in which the 1,2-vinyl bond content of the conjugated diene compound prior to hydrogenation is 30% to less than 70%. A block copolymer having such a block structure may, for example, be represented as A-B2-B1-A and may be obtained by a commonly known polymerization method in which the 1,2-vinyl bond content is controlled based on the feed sequence of each monomer unit that is produced.

The bound vinyl aromatic compound content in the hydrogenated block copolymer component (b-1) or the hydrogenated block copolymer component (b-2) is preferably 15 mass % to 80 mass %, more preferably 25 mass % to 80 mass %, and even more preferably 30 mass % to 75 mass %.

The hydrogenated block copolymer component (b-1) or the hydrogenated block copolymer component (b-2) can be used as a hydrogenated copolymer block (hydrogenated product of a vinyl aromatic compound-conjugated diene compound block copolymer) by performing a hydrogenation reaction to hydrogenate aliphatic double bonds such as those in polymer blocks B of mainly a conjugated diene compound. The percentage hydrogenation of these aliphatic double bonds is preferably 80% or more, and more preferably 95% or more. The percentage hydrogenation can normally be determined using an infrared spectrophotometer, an NMR spectrometer, or the like.

The bound vinyl aromatic compound content in the hydrogenated block copolymer (b) is preferably 15 mass % to 80 mass %, more preferably 25 mass % to 80 mass %, and even more preferably 30 mass % to 75 mass %.

The mass ratio of the hydrogenated block copolymer component (b-1) relative to the hydrogenated block copolymer component (b-2) (hydrogenated block copolymer component (b-1)/hydrogenated block copolymer component (b-2)) in the hydrogenated block copolymer (b) is 5/95 to 95/5, and preferably 10/90 to 90/10 from a viewpoint of impact resistance and fluidity.

The number average molecular weight (Mnc) of the hydrogenated block copolymer component (b-1) and/or the hydrogenated block copolymer component (b-2) is preferably 40,000 to 250,000. A number average molecular weight of 40,000 or more is preferable from a viewpoint of impact resistance, whereas a number average molecular weight of 250,000 or less is preferable from a viewpoint of dispersibility in component (a).

The number average molecular weight (Mnc) of the hydrogenated block copolymer component (b-1) and/or the hydrogenated block copolymer component (b-2) can be measured by preparing a calibration curve with standard polystyrene (standard polystyrene having molecular weights of U.S. Pat. Nos. 3,650,000, 2,170,000, 1,090,000, 681,000, 204,000, 52,000, 30,200, 13,800, 3,360, 1,300, and 550) using a Gel Permeation Chromatography System 21 (column: K-G×1, K-800RL×1, and K-800R×1 (produced by Showa Denko K.K.) connected in series in this order; column temperature: 40° C.; solvent: chloroform; solvent flow rate: 10 mL/minute; sample concentration: 1 g/L chloroform solution of hydrogenated block copolymer) produced by Showa Denko K.K., and setting the detector ultraviolet (UV) wavelength as 254 nm in measurement of both the standard polystyrene and the hydrogenated block copolymer component.

The number average molecular weight (MncA) of at least one block A among the polymer blocks A included in the hydrogenated block copolymer (b) is preferably 10,000 or more, and more preferably 15,000 or more, and is even more preferably more than 15,000 from a viewpoint of obtaining even better impact resistance. Moreover, from viewpoint of obtaining even better impact resistance, it is preferable that all the polymer blocks A included in the hydrogenated block copolymer (b) have a number average molecular weight (MncA) of 10,000 or more. The inclusion of polymer blocks A having a number average molecular weight (MncA) of 10,000 or more is preferable because a hydrogenated block copolymer satisfying this condition has good miscibility with PPE in component (a) having a weight average molecular weight (Mwppe) of 15,000 to 25,000 and a molecular weight distribution (Mwppe/Mnppe) of 1.5 to 3.0, and heat resistance and mechanical properties of the resultant resin composition are excellent.

In the case of an A-B-A type structure, the number average molecular weight (MncA) of the polymer blocks A of mainly a vinyl aromatic compound that are included in the hydrogenated block copolymer (b) can be calculated based on the number average molecular weight (Mnc) of the hydrogenated block copolymer component from an equation: MncA=Mnc×bound vinyl aromatic compound content ratio÷2, by assuming that the molecular weight distribution of the hydrogenated block copolymer component is 1 and that the two polymer blocks A of mainly a vinyl aromatic compound have the same molecular weight. In the same manner, in the case of the A-B-A-B type hydrogenated block copolymer component (b-1), the number average molecular weight (MncA) can be determined from an equation: MncA=Mnc×bound vinyl aromatic compound content ratio÷3. Also note that in a situation in which the sequence of the block structures A and B described above is clear at the stage of synthesis of the vinyl aromatic compound-conjugated diene compound block copolymer, the number average molecular weight (MncA) can be calculated from the ratio of block structure A based on the measured number average molecular weight (Mnc) of the hydrogenated block copolymer component without needing to use the above equations.

The hydrogenated block copolymer (b) preferably includes a polymer block B having a number average molecular weight (MncB) of 15,000 or more, and more preferably includes a polymer block B having a number average molecular weight of 40,000 or more from a viewpoint of obtaining even better impact resistance.

The number average molecular weight (MncB) of polymer blocks B of mainly a conjugated diene compound that are included in the hydrogenated block copolymer (b) can be calculated by the same method as described above.

It is preferable that the hydrogenated block copolymer (b) has a number average molecular weight (Mnc) of 40,000 to 250,000 and includes a polymer block A having a number average molecular weight (MncA) of 10,000 or more.

The hydrogenated block copolymer of component (b) can be produced by any method so long as the structure described above can be obtained. Examples of production methods that can be used include methods described in JP S47-11486 A, JP S49-66743 A, JP S50-75651 A, JP S54-126255 A, JP S56-10542 A, JP S56-62847 A, JP S56-100840 A, JP 2004-269665 A, GB 1130770 A, U.S. Pat. No. 3,281,383 A, U.S. Pat. No. 3,639,517 A, GB 1020720 A, U.S. Pat. No. 3,333,024 A, and U.S. Pat. No. 4,501,857 A.

The hydrogenated block copolymer of component (b) may be a modified hydrogenated block copolymer that is obtained, for example, by a method in which the above-described hydrogenated block copolymer is reacted with an α,β-unsaturated carboxylic acid or derivative thereof (ester compound or acid anhydride compound such as maleic anhydride) at a temperature of 80° C. to 350° C. in a molten state, solution state, or slurry state, and in the presence or absence of a radical precursor (for example, a modified hydrogenated block copolymer for which the grafted amount or added amount of the α,β-unsaturated carboxylic acid or derivative thereof is 0.01 mass % to 10 mass % relative to 100 mass % of component (b)). Moreover, the hydrogenated block copolymer of component (b) may be a mixture of a hydrogenated block copolymer such as described above and a modified hydrogenated block copolymer such as described above in any ratio.

The content of component (b) in the resin composition of the present embodiment when the total amount of components (a) and (b) is taken to be 100 mass % is preferably 2 mass % to 50 mass %, and more preferably 2 mass % to 30 mass % from a viewpoint of processability, heat resistance, impact resistance, ductile fracture properties, and flame retardance. When the content of component (b) is within a range of 2 mass % to 50 mass %, an adequate balance of processability, heat resistance, impact resistance, ductile fracture properties, and flame retardance can be obtained.

The mass ratio of component (a) relative to component (b) (polyphenylene ether resin (a)/hydrogenated block copolymer (b)) in the resin composition of the present embodiment is preferably 98/2 to 50/50, more preferably 98/2 to 40/60, and even more preferably 98/2 to 30/70 from a viewpoint of obtaining an even better balance of impact resistance and fluidity.

(Condensed Phosphate Ester Flame Retardant (c))

The resin composition of the present embodiment may contain a condensed phosphate ester flame retardant (c). Through inclusion of component (c), a flame retardance promoting effect of the polyphenylene ether resin of component (a) and a flame retardance imparting effect of component (c) act synergistically to exhibit a significant flame retardance and fluidity imparting effect with respect to the resin composition of the present embodiment.

The condensed phosphate ester flame retardant (c) may, for example, be a phosphate ester and/or condensate thereof represented by the following formula (2), but is not specifically limited thereto.

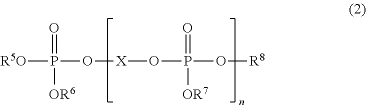

In formula (2), R⁵, R⁶, R⁷, and R⁸ are each, independently of one another, a monovalent group selected from the group consisting of a hydrogen atom, a halogen atom, an alkyl group, a cycloalkyl group, an aryl-substituted alkyl group, an aryl group, a halogen-substituted aryl group, and an alkyl-substituted aryl group. X represents an arylene group. Moreover, n is an integer of 0 to 5.

In the case of phosphate esters and/or condensates thereof having different values of n, n represents the average value of these values. Moreover, in a case in which n=0, the compound in formula (2) is a phosphate ester monomer.

Representative examples of phosphate ester monomers include, but are not specifically limited to, triphenyl phosphate, tricresyl phosphate, and trixylenyl phosphate.

In the case of a phosphate ester condensate, n can normally take an average value of 1 to 5, and is preferably an average value of 1 to 3.

Moreover, form a viewpoint of expression of flame retardance and heat resistance upon kneading with another resin, it is preferable that at least one of R⁵, R⁶, R⁷, and R⁸ is an aryl group, and more preferable that R⁵, R⁶, R⁷, and R⁸ are all aryl groups. For the same reasons, the aryl group is preferably a phenyl, xylenyl, cresyl, or halogenated derivative thereof.

The arylene group represented by X may, for example, be a residue resulting from elimination of two hydroxy groups from resorcinol, hydroquinone, bisphenol A, biphenol, or a halogenated derivative thereof.

Examples of condensed-type phosphate ester compounds include, but are not specifically limited to, resorcinol-bisphenyl phosphate compounds, bisphenol A-polyphenyl phosphate compounds, and bisphenol A-polycresyl phosphate compounds.

The content of component (c) in the resin composition of the present embodiment when the total amount of components (a) and (b) is taken to be 100 parts by mass is preferably 6 parts by mass to 20 parts by mass, more preferably 8 parts by mass to 20 parts by mass, and even more preferably 10 parts by mass to 18 parts by mass from a viewpoint of fluidity, heat resistance, and flame retardance. When the content of component (c) is within a range of 6 parts by mass to 20 parts by mass, a more adequate balance of fluidity, heat resistance, and flame retardance can be obtained.

(Other Components)

The resin composition of the present embodiment may contain other components as necessary to the extent that thermal conductivity, electrical resistance, fluidity, low volatile content, heat resistance, and flame retardance of the resin composition are not negatively affected.

Examples of these other components include, but are not specifically limited to, thermoplastic elastomers (non-hydrogenated block copolymers and polyolefin elastomers), heat stabilizers, antioxidants, metal deactivators, nucleating agents, flame retardants (for example, organophosphate ester compounds that do not correspond to component (c), ammonium polyphosphate compounds, and silicone flame retardants), plasticizers (for example, low molecular weight polyethylene, epoxidized soybean oil, polyethylene glycol, and fatty acid esters), weather (light) resistance enhancers, slip agents, inorganic or organic fillers or reinforcers (for example, carbon fiber, polyacrylonitrile fiber, and aramid fiber), various types of colorants, and release agents.

It is preferable that the resin composition of the present embodiment does not substantially contain polypropylene. When all resin components are taken to be 100 mass %, in total, the polypropylene content in the resin composition of the present embodiment is less than 5 mass %.

When the polypropylene content is less than 5 mass %, excellent fluidity, impact resistance, flame retardance, and ductile fracture properties can be obtained while also achieving an excellent balance with tensile strength. The polypropylene content when all resin components are taken to be 100 mass %, in total, is preferably 4 mass % or less, more preferably 3 mass % or less, and even more preferably 2 mass % or less.

Note that “all resin components” refers to all resins that are contained in the resin composition of the present embodiment.

[Production Method of Resin Composition]

The resin composition of the present embodiment can be produced by melt-kneading component (a), component (b), and, as necessary, component (c) and other components.

Examples of melt-kneading machines that can be used to perform the melt-kneading include, but are not limited to, machines that perform heated melt-kneading through a single screw extruder, a multi-screw extruder such as a twin screw extruder, a roll, a kneader, a Brabender Plastograph, a Banbury mixer, or the like. In particular, a twin screw extruder is preferable from a viewpoint of kneadability. Specific examples include the ZSK series produced by Werner & Pfleiderer, the TEM series produced by Toshiba Machine Co., Ltd., and the TEX series produced by The Japan Steel Works, Ltd.

The following describes a preferable production method using an extruder.

L/D (effective barrel length/barrel internal diameter) of the extruder is preferably at least 20 and not more than 60, and more preferably at least 30 and not more than 50.

Although no specific limitations are placed on the configuration of the extruder, the extruder preferably includes a first raw material feeding inlet at an upstream side relative to the direction of raw material flow, a first vacuum vent further downstream than the first raw material feeding inlet, a second raw material feeding inlet downstream of the first vacuum vent (and also third and fourth raw material feeding inlets downstream of the second raw material feeding inlet as necessary), and a second vacuum vent downstream of the second raw material feeding inlet. In particular, it is more preferable that a kneading section is provided upstream of the first vacuum vent, a kneading section is provided between the first vacuum vent and the second raw material feeding inlet, a kneading section is provided between the second to fourth raw material feeding inlets and the second vacuum vent, and a kneading section is provided between the second to fourth raw material feeding inlets and the second vacuum vent.

Although no specific limitations are placed on the method by which raw materials are fed at the second to fourth raw material feeding inlets, it is preferable to adopt a method in which raw materials are fed from a side opening in the extruder using a forced side feeder because this tends to enable more stable feeding than when raw materials are simply added through an opening at the second to fourth raw material feeding inlets of the extruder.

In particular, in a situation in which a powder is included among the raw materials and it is desirable to reduce production of crosslinked products or carbides due to resin heat history, a method in which a forced side feeder is used for feeding from the side of the extruder is more preferable, and a method in which forced side feeders are provided at the second to fourth raw material feeding inlets, and such raw material powders are divided into portions for feeding is even more preferable.

Moreover, in a situation in which a liquid raw material is to be added, it is preferable to adopt a method of addition into the extruder using a plunger pump, a gear pump, or the like.

Furthermore, upper openings in the extruder at the second to fourth raw material feeding inlets may be used as openings for removing accompanying air.

No specific limitations are placed on the melt-kneading temperature and the screw rotation speed in a process of melt-kneading the resin composition. A temperature that, in the case of a crystalline resin, is at least the melting point of the crystalline resin and, in the case of an amorphous resin, is at least the glass transition temperature of the amorphous resin, may be selected such as to enable melt-kneading and processing without difficulty. Normally, the melt-kneading temperature can be freely selected from 200° C. to 370° C., and the screw rotation speed can be 100 rpm to 1,200 rpm.

In one specific example of a production method of the resin composition of the present embodiment using a twin screw extruder, the polyphenylene ether resin of component (a) and the hydrogenated block copolymer of component (b) are fed from a first raw material feeding inlet of the twin screw extruder, these components are melt-kneaded with a screw rotation speed of 100 rpm to 1,200 rpm, and preferably 200 rpm to 500 rpm, by setting a heated melting zone of the twin screw extruder as the melting temperature of the polyphenylene ether resin, optionally feeding the condensed phosphate ester flame retardant of component (c) from a second raw material feeding inlet of the twin screw extruder while the components (a) and (b) are in a melt-kneaded state, and then performing further melt-kneading. In terms of the position at which components (a) and (b) are fed into the twin screw extruder, these components may each be supplied from the first raw material feeding inlet of the extruder as a single portion as previously described, or second, third, and fourth raw material feeding inlets may be provided in the extruder and the each of these components may be divided into portions for feeding.

In a situation in which production of crosslinked products or carbides due to resin heat history in the presence of oxygen is to be reduced, the oxygen concentration in individual process lines of addition paths for raw materials into the extruder is preferably maintained at less than 1.0 volume %. Although these addition paths are not specifically limited, in one specific example of configuration, an addition path comprises, in this order, piping leading from a stock tank, a gravimetric feeder having a refill tank, piping, a feed hopper, and the twin screw extruder. The method by which a low oxygen concentration is maintained is not specifically limited, but a method of introducing an inert gas into individual process lines having increased air tightness is an effective method. In general, it is preferable that nitrogen gas is introduced into the process lines to maintain an oxygen concentration of less than 1.0 volume %.

In a situation in which the polyphenylene ether resin of component (a) includes a component that is in the form of a powder (volume average particle diameter of less than 10 μm), the resin composition production method described above has an effect of reducing residual matter in screws of a twin screw extruder during production of the resin composition of the present embodiment using the twin screw extruder, and also has an effect of reducing generation of black spot foreign matter, carbides, and the like in the resultant resin composition obtained by the production method described above.

More specifically, production of the resin composition of the present embodiment is preferably implemented by any of the following methods 1 to 3 using an extruder in which the oxygen concentration of each raw material feeding inlet is controlled to less than 1.0 volume %.

1. A production method involving melt-kneading all or part of component (a) and component (b) contained in the resin composition of the present embodiment (first kneading step), feeding the remainder of components (a) and (b) and all of component (c) with respect to the molten kneaded product that is obtained through the first kneading step, and performing further kneading (second kneading step)

2. A production method involving melt-kneading all of component (a) contained in the resin composition of the present embodiment (first kneading step), performing cooling and pelletization, and subsequently feeding all of the other components (b) and (c) and performing melt-kneading (second kneading step)

3. A production method involving melt-kneading all of component (a), component (b), and component (c) contained in the resin composition of the present embodiment

In particular, since there are cases in which the polyphenylene ether used as a raw material of component (a) and, depending on the molecular structure, the hydrogenated block copolymer of component (b) are in the form of powders, and component (c) is in the form of a liquid, biting-in properties to an extruder are poor and it is difficult to increase production output per unit time. Moreover, resin thermal degradation tends to occur due to the long residence time of resin in the extruder. For these reasons, a resin composition obtained by production method 1 or 2 is more preferable because, compared to a resin composition obtained by production method 3, mixing of components is excellent, production of crosslinked products and carbides due to thermal degradation can be reduced, resin production output per unit time can be increased, and a resin composition having excellent producibility and quality can be obtained.

Herein, “a kneaded product is in a molten state from a first kneading step to a second kneading step” is not inclusive of a case in which component (a) is melted once, and is subsequently melted again after being pelletized.

[Shaped Product]

A shaped product of the resin composition of the present embodiment can be widely used as shaped products such as optical device mechanism parts, light source lamp peripheral parts, sheets or films for metal film-laminated substrates, hard disk internal parts, connector ferrules for optical fibers, printer parts, photocopier parts, automobile engine compartment internal parts such as automobile radiator tank parts, and automobile lamp parts.

### Examples

The following describes the present embodiment through specific examples and comparative examples. However, the present embodiment is not limited to these examples.

The following methods were used to measure physical properties in the examples and comparative examples.

### ((1) Impact Resistance)

### (1-1) Falling Weight Impact Test

Total absorbed energy (J) was measured by the method described in ISO 6603-2. A higher value was evaluated to indicate better impact resistance.

In addition, the fracture surface was observed to judge whether ductile fracture or brittle fracture had occurred.

The judgement criteria were as follows.

Ductile fracture: Specimen surface is whitened and conically deformed without cracking.

Moreover, fragments are not produced even if cracking occurs.

Brittle fracture: A hole is opened in the shape of a circular fixing jig without whitening of the specimen surface.

Moreover, fragments are produced.

### (1-2) Charpy Impact Test

The Charpy impact strength (kJ/m²) was measured by the method described in ISO 179. A higher value was evaluated to indicate better impact resistance.

### ((2) Fluidity)

The injection pressure in production of a UL-94 specimen was lowered to measure the pressure (MPa) at which resin no longer reached the end of the mold (SSP: short shot pressure). A lower value was evaluated to indicate better fluidity.

### ((3) Flame Retardance (UL-94))

In Examples 1, 10, and 13, and Comparative Examples 3 and 4, a test was conducted in accordance with the UL-94 (standard defined by Under Writers Laboratories Inc. (United States of America)) vertical burning test method.

### ((4) Tensile Strength and Tensile Elongation)

Tensile strength (MPa) and tensile elongation (%) were measured by the method described in ISO 527. A higher value was evaluated to indicate better tensile strength or tensile elongation.

Raw materials used in the examples and comparative examples were as follows.

### <Component (a): Polyphenylene Ether Resin>

(a1): PPE (Polyphenylene Ether)

Polyphenylene ether obtained through oxidative polymerization of 2,6-xylenol (reduced viscosity of 0.51 dL/g as measured at 30° C. using a chloroform solution of 0.5 g/dL in concentration)

(a2): High impact polystyrene (product name: Polystyrene H9405; produced by PS Japan Corporation)

<Component (b): Hydrogenated Block Copolymer>

The following hydrogenated block copolymer components were synthesized. Note that the numbers in parentheses indicate the number average molecular weight of polystyrene blocks and hydrogenated polybutadiene blocks.

(b1-1): Hydrogenated block copolymer having a polystyrene (12,000)-hydrogenated polybutadiene (9,000)-polystyrene (12,000)-hydrogenated polybutadiene (9,000) structure in which the percentage hydrogenation of polybutadiene sections was 99.8%

(b1-2): Hydrogenated block copolymer having a polystyrene (40,000)-hydrogenated polybutadiene (100,000)-polystyrene (40,000)-hydrogenated polybutadiene (30,000) structure in which the percentage hydrogenation of polybutadiene sections was 99.9%

(b1-3): Hydrogenated block copolymer having a polystyrene (11,000)-hydrogenated polybutadiene (8,000)-polystyrene (11,000)-hydrogenated polybutadiene (8,000) structure in which the percentage hydrogenation of polybutadiene sections was 99.8%

(b1-4): Hydrogenated block copolymer having a polystyrene (9,000)-hydrogenated polybutadiene (13,000)-polystyrene (8,000)-hydrogenated polybutadiene (14,000) structure in which the percentage hydrogenation of polybutadiene sections was 99.9%

(b2-1): Hydrogenated block copolymer having a polystyrene (15,000)-hydrogenated polybutadiene (12,000)-polystyrene (15,000) structure in which the percentage hydrogenation of polybutadiene sections was 99.7%

(b2-2): Hydrogenated block copolymer having a polystyrene (40,000)-hydrogenated polybutadiene (100,000)-polystyrene (40,000) structure in which the percentage hydrogenation of polybutadiene sections was 99.8%

(b2-3): Hydrogenated block copolymer having a polystyrene (10,000)-hydrogenated polybutadiene (24,000)-polystyrene (8,000) structure in which the percentage hydrogenation of polybutadiene sections was 99.8%

(b2-4): Hydrogenated block copolymer having a polystyrene (9,000)-hydrogenated polybutadiene (24,000)-polystyrene (9,000) structure in which the percentage hydrogenation of polybutadiene sections was 99.8%

<Component (c): Condensed Phosphate Ester Flame Retardant>

(c1): Aromatic condensed phosphate ester (product name: CR-741; produced by Daihachi Chemical Industry Co., Ltd.)

<(d) Other Components: Polypropylene>

(d1): Polypropylene (product name: NOVATEC® PP MA3 (NOVATEC is a registered trademark in Japan, other countries, or both); produced by Japan Polypropylene Corporation)

### Examples 1 to 13 and Comparative Examples 1 to 4

Resin compositions were produced using a twin screw extruder ZSK-40 (produced by Werner & Pfleiderer). The twin screw extruder included a first raw material feeding inlet at an upstream side relative to the direction of raw material flow, a first vacuum vent and a second raw material feeding inlet further downstream than the first raw material feeding inlet, and a second vacuum vent downstream thereof. Feeding at the second raw material feeding inlet was performed from an opening at the top of the extruder using a gear pump.

Using the extruder set up as described above, components (a), (b), and (d) with the compositions shown above were added from the first raw material feeding inlet, the condensed phosphate ester flame retardant (c) was added from the second raw material feeding inlet, and melt-kneading was performed under conditions of an extrusion temperature of 240° C. to 310° C., a screw rotation speed of 300 rpm, and a discharge rate of 100 kg/hour to produce pellets.

The resin composition pellets were supplied into a screw inline type injection molding machine set to 250° C. to 310° C. and, at a mold temperature of 60° C. to 120° C., were used to obtain a plate-shaped molded product in the form of a 75 mm square having a thickness of 3 mm. The obtained plate-shaped molded product was left for at least 24 hours at 23° C. and 50% relative humidity, and was then subjected to the falling weight impact test described in section (1-1).

Moreover, a type A specimen in accordance with ISO 10724-1 was molded under the same injection molding conditions. This specimen was used to perform a tensile strength test (ISO 527), and to measure tensile strength and tensile elongation as described in section (4) and Charpy impact strength (ISO 179) as described in section (1-2).

In addition, a specimen of 127 mm in length, 12.7 mm in width, and 1.6 mm in thickness was molded under the same injection molding conditions. This specimen was used to perform a vertical burning test in accordance with UL-94 and evaluate flame retardance (UL-94) as described in section (3). In this molding, the injection pressure was lowered to measure the pressure at which resin no longer reached the end of the mold (SSP: short shot pressure).

The results are shown together in Table 1.

Note that the additive amounts of components (a) and (b) shown in Table 1 are ratios relative to 100 mass %, in total, of components (a) and (b). Moreover, the additive amount of component (c) is a ratio relative to 100 parts by mass, in total, of components (a) and (b). Furthermore, the additive amount of component (d) is the mass ratio when the total amount of all resins contained in the resin composition is taken to be 100 mass %.

As can be seen from Table 1, the resin compositions of Examples 1 to 13 had excellent fluidity, impact resistance, and ductile fracture properties, and also had an excellent balance with tensile strength.

In Comparative Examples 1 to 4, a poor result was obtained for either fluidity or impact resistance compared to the examples. Moreover, the balance with tensile strength was poor.

TABLE 1

| | | | | Example 1 | Example 2 | Example 3 | Example 4 | Example 5 | Example 6 | Example 7 |
|---|---|---|---|---|---|---|---|---|---|---|
| Resin | Component | (a1) PPE | Mass % | 70 | 70 | 70 | 70 | 70 | 70 | 70 |
| composition | (a) | (a2) HIPS | Mass % | 20 | 20 | 20 | 20 | 20 | 20 | 25 |
| | Component | (b1-1) Hydrogenated block | Mass % | 5 | — | — | — | — | 5 | 2.5 |
| | (b) | copolymer component | | | | | | | | |
| | | (b1-2) Hydrogenated block | Mass % | — | — | — | — | 5 | — | — |
| | | copolymer component | | | | | | | | |
| | | (b1-3) Hydrogenated block | Mass % | — | 5 | — | — | — | — | — |
| | | copolymer component | | | | | | | | |
| | | (b1-4) Hydrogenated block | Mass % | — | — | 5 | 5 | — | — | — |
| | | copolymer component | | | | | | | | |
| | | (b2-1) Hydrogenated block | Mass % | 5 | 5 | — | — | 5 | — | 2.5 |
| | | copolymer component | | | | | | | | |
| | | (b2-2) Hydrogenated block | Mass % | — | — | — | — | — | 5 | — |
| | | copolymer component | | | | | | | | |
| | | (b2-3) Hydrogenated block | Mass % | — | — | 5 | — | — | — | — |
| | | copolymer component | | | | | | | | |
| | | (b2-4) Hydrogenated block | Mass % | — | — | — | 5 | — | — | — |
| | | copolymer component | | | | | | | | |
| | Component | (c-1) Condensed phosphate | Parts by | — | — | — | — | — | — | — |
| | (c) | ester flame retardant | mass | | | | | | | |
| | Component | (d-1) Polypropylene | Mass % | — | — | — | — | — | — | — |
| | (d) | | | | | | | | | |
| Physical | Impact | Falling weight impact test | J | 38 | 33 | 35 | 32 | 46 | 45 | 34 |
| properties | resistance | (total absorbed energy) | | Ductile | Ductile | Ductile | Ductile | Ductile | Ductile | Ductile |
| | | (Type of fracture) | | | | | | | | |
| | | Charpy impact strength | kJ/m² | 31 | 26 | 30 | 24 | 39 | 40 | 34 |
| | | (notch present) | | | | | | | | |
| | Fluidity | Short shot-pressure | MPa | 84 | 80 | 81 | 82 | 88 | 87 | 80 |
| | Flame | UL-94 (1.6 mm) | | HB | — | — | — | — | — | — |
| | retardance | | | | | | | | | |
| | Tensile test | Tensile strength | MPa | 106 | 107 | 105 | 98 | 102 | 103 | 104 |
| | | Tensile elongation | % | 42 | 34 | 39 | 31 | 61 | 63 | 44 |
| | | | | | | | | | | Com- |
| | | | | | | Example | Example | Example | Example | parative |
| | | | | Example 8 | Example 9 | 10 | 11 | 12 | 13 | Example 1 |
| Resin | Component | (a1) PPE | Mass % | 5 | 20 | 70 | 70 | 70 | 70 | 70 |
| composition | (a) | (a2) HIPS | Mass % | — | 70 | 20 | 20 | 20 | 16 | 20 |
| | Component | (b1-1) Hydrogenated block | Mass % | ‘ 47.5 | 5 | 5 | 9 | 1 | 5 | 10 |
| | (b) | copolymer component | | | | | | | | |
| | | (b1-2) Hydrogenated block | Mass % | — | — | — | — | — | — | — |
| | | copolymer component | | | | | | | | |
| | | (b1-3) Hydrogenated block | Mass % | — | — | — | — | — | — | — |
| | | copolymer component | | | | | | | | |
| | | (b1-4) Hydrogenated block | Mass % | — | — | — | — | — | — | — |
| | | copolymer component | | | | | | | | |
| | | (b2-1) Hydrogenated block | Mass % | 47.5 | 5 | 5 | 1 | 9 | 5 | — |
| | | copolymer component | | | | | | | | |
| | | (b2-2) Hydrogenated block | Mass % | — | — | — | — | — | — | — |
| | | copolymer component | | | | | | | | |
| | | (b2-3) Hydrogenated block | Mass % | — | — | — | — | — | — | — |
| | | copolymer component | | | | | | | | |
| | | (b2-4) Hydrogenated block | Mass % | — | — | — | — | — | — | — |
| | | copolymer component | | | | | | | | |
| | Component | (c-1) Condensed phosphate | Parts by | — | — | 10 | — | — | — | — |
| | (c) | ester flame retardant | mass | | | | | | | |
| | Component | (d-1) Polypropylene | Mass % | — | — | — | — | — | 4 | — |
| | (d) | | | | | | | | | |
| Physical | Impact | Falling weight impact test | J | 86 | 36 | 34 | 39 | 38 | 33 | 34 |
| properties | resistance | (total absorbed energy) | | Ductile | Ductile | Ductile | Ductile | Ductile | Ductile | Ductile |
| | | (Type of fracture) | | | | | | | | |
| | | Charpy impact strength | kJ/m² | NB* | 42 | 28 | 33 | 31 | 36 | 30 |
| | | (notch present) | | | | | | | | |
| | Fluidity | Short shot-pressure | MPa | 39 | 42 | 74 | 83 | 85 | 87 | 87 |
| | Flame | UL-94 (1.6 mm) | | — | — | V-0 | — | — | HB | — |
| | retardance | | | | | | | | | |
| | Tensile test | Tensile strength | MPa | 15 | 100 | 108 | 98 | 106 | 98 | 81 |
| | | Tensile elongation | % | 30 | 37 | 40 | 46 | 40 | 43 | 44 |

| | | | | Comparative | Comparative | Comparative |
|---|---|---|---|---|---|---|
| | | | | Example 2 | Example 3 | Example 4 |
| Resin | Component | (a1) PPE | Mass % | 70 | 70 | 70 |
| composition | (a) | (a2) HIPS | Mass % | 20 | 15 | 15 |
| | Component | (b1-1) Hydrogenated block | Mass % | — | 5 | 5 |
| | (b) | copolymer component | | | | |
| | | (b1-2) Hydrogenated block | Mass % | — | — | — |
| | | copolymer component | | | | |
| | | (b1-3) Hydrogenated block | Mass % | — | — | — |
| | | copolymer component | | | | |
| | | (b1-4) Hydrogenated block | Mass % | — | — | — |
| | | copolymer component | | | | |
| | | (b2-1) Hydrogenated block | Mass % | 10 | 5 | 5 |
| | | copolymer component | | | | |
| | | (b2-2) Hydrogenated block | Mass % | — | — | — |
| | | copolymer component | | | | |
| | | (b2-3) Hydrogenated block | Mass % | — | — | — |
| | | copolymer component | | | | |
| | | (b2-4) Hydrogenated block | Mass % | — | — | — |
| | | copolymer component | | | | |
| | Component | (c-1) Condensed phosphate | Parts by | — | — | 10 |
| | (c) | ester flame retardant | mass | | | |
| | Component | (d-1) Polypropylene | Mass % | — | 5 | 5 |
| | (d) | | | | | |
| Physical | Impact | Falling weight impact test | J | 33 | 29 | 28 |
| properties | resistance | (total absorbed energy) | | Brittle | Ductile | Brittle |
| | | (Type of fracture) | | | | |
| | | Charpy impact strength | kJ/m² | 24 | 35 | 29 |
| | | (notch present) | | | | |
| | Fluidity | Short shot-pressure | MPa | 89 | 92 | 79 |
| | Flame | UL-94 (1.6 mm) | | — | HB | V-2 |
| | retardance | | | | | |
| | Tensile test | Tensile strength | MPa | 105 | 92 | 99 |
| | | Tensile elongation | % | 20 | 44 | 38 |

*No fracture in Charpy impact test (4J)

### INDUSTRIAL APPLICABILITY

A shaped product that is shaped from the resin composition of the present embodiment has excellent heat resistance and flame retardance, and high impact resistance, and also has excellent ductile fracture properties and fluidity, which enables a higher degree of resin shaped product design freedom. Therefore, the shaped product can be used as various parts in electrical and electronic devices, automobile devices, chemical devices, and optical devices, and is industrially applicable as, for example, a chassis or cabinet for a digital versatile disk, an optical device mechanism part such as an optical pick-up slide base, a light source lamp peripheral part, a sheet or film for a metal film-laminated substrate, a hard disk internal part, a connector ferrule for optical fibers, a laser beam printer internal part (for example, a toner cartridge), an inkjet printer internal part, a photocopier internal part, an automobile engine compartment internal part such as an automobile radiator tank part, or an automobile lamp part.

1. A resin composition comprising:
a polyphenylene ether resin (a); and
a hydrogenated block copolymer (b) including a hydrogenated block copolymer component (b-1) that includes two polymer blocks A of mainly a vinyl aromatic compound and two polymer blocks B of mainly a conjugated diene compound, and a hydrogenated block copolymer component (b-2) that includes two polymer blocks A of mainly a vinyl aromatic compound and one polymer block B of mainly a conjugated diene compound, with a mass ratio of the hydrogenated block copolymer component (b-1) relative to the hydrogenated block copolymer component (b-2) of 5/95 to 95/5, wherein
polypropylene content is less than 5 mass % when all resin components are taken to be 100 mass %, in total.

2. The resin composition according to claim 1, wherein
the polyphenylene ether resin (a) includes a polyphenylene ether and a polystyrene resin, and
a mass ratio of the polyphenylene ether relative to the polystyrene resin is 97/3 to 5/95.

3. The resin composition according to claim 2, wherein
the polystyrene resin is either or both of atactic polystyrene and high impact polystyrene.

4. The resin composition according to claim 1, wherein
at least one of the polymer blocks A has a number average molecular weight of 10,000 or more.

5. The resin composition according to claim 1, wherein
either or both of the hydrogenated block copolymer component (b-1) and the hydrogenated block copolymer component (b-2) have a number average molecular weight of 40,000 to 250,000.

6. The resin composition according to claim 1, wherein
a mass ratio of the polyphenylene ether resin (a) relative to the hydrogenated block copolymer (b) is 98/2 to 50/50.

7. The resin composition according to claim 1, further comprising
6 parts by mass to 20 parts by mass of a condensed phosphate ester flame retardant (c) relative to 100 parts by mass, in total, of the polyphenylene ether resin (a) and the hydrogenated block copolymer (b).
